(19) United States
(12) Patent Application Publication
(10) Pub. No.: US 2026/0274732 A1
(43) Pub. Date: Sep. 17, 2026

(54) CLARIFYING DEVICE, METHOD FOR PRODUCING GLASS ARTICLE, AND TUBULAR MEMBER

(71) Applicant: Nippon Electric Glass Co., Ltd., Shiga (JP)

(72) Inventor: Shusaku TAMAMURA, Shiga (JP)

(21) Appl. No.: 19/168,032

(22) PCT Filed: Apr. 4, 2024
(86) PCT No.: PCT/JP2024/013934

§ 371 Date: Sep. 23, 2025

(30) Foreign Application Priority Data
Apr. 17, 2023 (JP) 2023-067092

(51) Int. Cl. C03B 5/225

(52) U.S. Cl. CPC C03B 5/225

(57) ABSTRACT

Provided is a fining device (3), including: a fining pipe (8) which is disposed in a lateral orientation and is configured to allow a molten glass (MG) to flow therethrough; and vent pipes (9) which extend upward from the fining pipe (8) and are configured to discharge gas bubbles (B) from the molten glass (MG) to an outside of the fining pipe (8). The vent pipes (9) are arranged at multiple positions along the fining pipe (8) in a flowing direction (D) of the molten glass (MG). The vent pipes (9) are arranged such that their lengths (L1, L2) increase progressively toward an upstream side in the flowing direction (D).

### TECHNICAL FIELD

The present disclosure relates to a fining device configured to remove gas bubbles from a molten glass, a manufacturing method for a glass article including a fining step using the fining device, and a tubular member for use in the fining device.

### BACKGROUND ART

Glass articles such as glass sheets, glass tubes, and the like are manufactured through a melting step, a fining step, a homogenization step, a forming step, and the like. In the melting step, glass raw materials are melted to produce a molten glass. In the fining step, gas bubbles are removed from the molten glass. In the homogenization step, the molten glass is stirred to homogenize it. In the forming step, a glass article is formed from the molten glass.

In the above-mentioned manufacturing process for a glass article, the fining step is carried out by using a fining device disclosed in Patent Literature 1 as one example.

As illustrated in FIG. 5, a fining device 100 disclosed in Patent Literature 1 includes a fining pipe 200 and vent pipes 300. The fining pipe 200 is disposed in a lateral orientation and allows a molten glass MG to flow therethrough. The vent pipes 300 extend upward from the fining pipe 200 and discharge gas bubbles B in the molten glass MG to an outside of the fining pipe 200. The vent pipes 300 are arranged at multiple positions (two positions in the illustrated example) along the fining pipe 200 in a flowing direction D of the molten glass MG. The fining pipe 200 and the vent pipes 300 are made of a precious metal such as platinum or a platinum alloy.

When the fining step is carried out by using the fining device 100, the gas bubbles B are removed from the molten glass MG through the vent pipes 300 while the molten glass MG flowing through the fining pipe 200 is being heated by electrically heating the fining pipe 200. Although not disclosed in Patent Literature 1, it is common to add a fining agent (for example, SnO₂) to the glass raw materials to promote the growth of the gas bubbles B in the molten glass MG and facilitate their rise.

### CITATION LIST

### Patent Literature

Patent Literature 1: JP 2022-50001 A

### SUMMARY OF INVENTION

### Technical Problem

To prevent the molten glass MG from flowing out from the vent pipes 300, an opening 300a (discharge port for the gas bubbles B) formed at an upper end of each of the vent pipes 300 is positioned higher than a liquid surface of the molten glass MG in a melting furnace (not shown in FIG. 5) in which the melting step is carried out. Even in this case, however, a bubbly glass (foam-like glass formed above the molten glass MG in the vent pipes 300) may spurt out from the vent pipes 300. Specifically, the bubbly glass is more likely to spurt out from the vent pipe 300 that is arranged on the upstream side in the flowing direction D of the molten glass MG. This is because a pressure of the molten glass MG inside the fining pipe 200 is higher on the upstream side, resulting in a higher liquid surface. Thus, whether a pipe axis of the fining pipe 200 is inclined with respect to a horizontal plane (as illustrated in FIG. 5) or parallel to it, the bubbly glass is more likely to spurt out from the vent pipe 300 that is arranged on the upstream side.

When the bubbly glass spurts out from the vent pipes 300, bricks (not shown in FIG. 5) around the vent pipes 300 are eroded by the bubbly glass. As a result, the bricks become worn and damaged, eventually causing the vent pipes 300 to, for example, fall over or break. Thus, a technology is needed to prevent the spurting of the bubbly glass from the vent pipes 300.

In view of the above-mentioned circumstances, the technical problem to be solved is to prevent a bubbly glass from spurting out from vent pipes when gas bubbles are removed from a molten glass using a fining device equipped with the vent pipes.

### Solution to Problem

In order to achieve the object described above, there is provided a first fining device comprising: a fining pipe which is disposed in a lateral orientation and is configured to allow a molten glass to flow therethrough; and a vent pipe which extends upward from the fining pipe and is configured to discharge gas bubbles from the molten glass to an outside of the fining pipe. A plurality of vent pipes is arranged at multiple positions along the fining pipe in a flowing direction of the molten glass. The plurality of vent pipes is arranged such that their lengths increase progressively toward an upstream side in the flowing direction.

In the first fining device, the vent pipes arranged at multiple positions along the fining pipe are formed such that their lengths progressively increase toward the upstream side in the flowing direction of the molten glass. This configuration prevents the spurting of a bubbly glass from the vent pipes due to a higher pressure of the molten glass on the upstream side.

There is provided a second fining device in which, in the above-mentioned first fining device, a pipe axis of the fining pipe is inclined with respect to a horizontal plane, and the fining pipe forms an upward slope from the upstream side toward a downstream side in the flowing direction.

In the second fining device, the fining pipe forms an upward slope from the upstream side toward the downstream side in the flowing direction. Thus, in comparison with the case in which the fining pipe is arranged horizontally, the pressure in the molten glass on the upstream side becomes even higher, resulting in a higher risk of spurting of the bubbly glass from the upstream vent pipe. Even in this case, however, the spurting of the bubbly glass can be prevented because the vent pipe arranged on the upstream side is formed longer. Thus, the second fining device can favorably enjoy the effect of preventing the spurting of the bubbly glass.

There is provided a third fining device in which, in the above-mentioned first or second fining device, a pipe axis of the vent pipe extends parallel to a vertical direction.

In the third fining device, the pipe axis of the vent pipe extends parallel to the vertical direction. Thus, the following advantage is obtained. In a case in which the pipe axis of the vent pipe is inclined with respect to the vertical direction, when the bubbly glass spurts out from the vent pipe, only a brick supporting the vent pipe on an inclined side is more likely to be eroded by the bubbly glass. Thus, there arises a risk of falling over of the vent pipe. Meanwhile, with the vent pipe having the pipe axis extending parallel to the vertical direction, even when the bubbly glass spurts out from the vent pipe, only the brick at a specific position can be prevented from being eroded by the bubbly glass. Based on the above-mentioned advantage, the falling over of the vent pipe can be appropriately prevented in the third fining device.

There is provided a fourth fining device in which, in any one of the above-mentioned first to third fining devices, the vent pipe comprises: a large-diameter portion having a relatively large inner diameter; and a small-diameter portion having a relatively small inner diameter, the large-diameter portion constitutes a lower end portion of the vent pipe which is connected to the fining pipe, and the small-diameter portion constitutes an upper end portion of the vent pipe in which an opening is formed.

In the fourth fining device, with the large-diameter portion connected to the fining pipe, a capacity of the vent pipe for receiving the bubbly glass can be increased. Thus, the spurting of bubbly glass from the vent pipe can be more effectively prevented. Further, the provision of the large-diameter portion stabilizes an orientation of the vent pipe, and thus the vent pipe can be prevented from falling over and breaking. Further, since the small-diameter portion constitutes the upper end of the vent pipe, the opening is naturally small. Thus, the intrusion of foreign matter from the opening is more easily prevented. In addition, a surface area of the vent pipe is suppressed and the vent pipe is less likely to be cooled due to the presence of the small-diameter portion. Thus, the bursting of bubbles is promoted. This also enables more effective prevention of the spurting of the bubbly glass from the vent pipe.

There is provided a fifth fining device, in which, in any one of the above-mentioned first to fourth fining devices, the fining device further comprises a supporting brick that surrounds and supports the fining pipe, and the vent pipe penetrates the supporting brick.

In the fifth fining device, each of the vent pipes is extended through the supporting brick, resulting in a longer pipe length. Thus, the spurting of bubbly glass from the vent pipes can be more effectively prevented.

There is provided a sixth fining device in which, in the above-mentioned fifth fining device, the fining device further comprises a retaining brick which supports a portion of the vent pipe protruding upward from the supporting brick, and at least part of the retaining brick has erosion resistance to the molten glass.

In the sixth fining device, at least part of the retaining brick has erosion resistance to the molten glass. Thus, even when the bubbly glass spurts out from the vent pipe, the retaining brick is less likely to be eroded. As a result, the vent pipe can be reliably prevented from falling over.

There is provided a seventh fining device in which, in any one of the above-mentioned first to sixth fining devices, the fining device further comprises a surrounding member which surrounds an upper end portion of the vent pipe in which an opening is formed.

In the seventh fining device, with the surrounding member surrounding the upper end portion of the vent pipe, so that intrusion of foreign matter into the vent pipe through the opening can be reliably prevented.

In order to achieve the object described above, there is provided an eighth fining device comprising: a fining pipe which is disposed in a lateral orientation and is configured to allow a molten glass to flow therethrough; and a vent pipe which extends upward from the fining pipe and is configured to discharge gas bubbles from the molten glass to an outside of the fining pipe. The vent pipe comprises: a large-diameter portion having a relatively large inner diameter; and a small-diameter portion having a relatively small inner diameter. The large-diameter portion constitutes a lower end portion of the vent pipe which is connected to the fining pipe. The small-diameter portion constitutes an upper end portion of the vent pipe in which an opening is formed.

In the eighth fining device, the capacity of the vent pipe for receiving the bubbly glass can be increased because of the presence of the large-diameter portion of the vent pipe which is connected to the fining pipe. Thus, the bubbly glass can be prevented from spurting out from the vent pipe. Further, the surface area of the vent pipe can be suppressed and the vent pipe is less likely to be cooled because of the presence of the small-diameter portion of the vent pipe. Thus, the bursting of bubbles can be promoted. This also enables the prevention of spurting of the bubbly glass from the vent pipe.

In order to achieve the object described above, there is provided a manufacturing method for a glass article, using any one of the above-mentioned first to eighth fining devices, and comprising a fining step of discharging gas bubbles from a molten glass that fills the fining pipe to the outside of the fining pipe through the vent pipe.

This manufacturing method for a glass article enables the above-mentioned effects of the first to eighth fining devices to be similarly obtained.

In order to achieve the object described above, there is provided a tubular member for use in a fining device, the tubular member comprising: a fining pipe which is disposed in a lateral orientation and is configured to allow a molten glass to flow therethrough; and a vent pipe which extends upward from the fining pipe and is configured to discharge gas bubbles from the molten glass to an outside of the fining pipe. A plurality of vent pipes is arranged at multiple positions along the fining pipe in a flowing direction of the molten glass. The plurality of vent pipes is arranged such that their lengths increase progressively toward an upstream side in the flowing direction.

The use of this tubular member in the fining device enables the above-mentioned effects of the first fining device to be similarly obtained.

### Advantageous Effects of Invention

With the fining device, the manufacturing method for a glass article, and the tubular member according to the present disclosure, when gas bubbles are removed from the molten glass by using the fining device equipped with the vent pipes, the bubbly glass can be prevented from spurting out from the vent pipes.

### BRIEF DESCRIPTION OF DRAWINGS

FIG. 1 is a side view for illustrating a manufacturing method for a glass article.

FIG. 2 is a side view for illustrating a fining device.

FIG. 3 is a transverse sectional view for illustrating the fining device.

FIG. 4 is a longitudinal sectional view for illustrating the fining device.

FIG. 5 is a longitudinal sectional view for illustrating a related-art fining device.

### DESCRIPTION OF EMBODIMENTS

Now, a fining device, a manufacturing method for a glass article, and a tubular member according to an embodiment are described with reference to the accompanying drawings. In the manufacturing method for a glass article described below, a glass sheet is manufactured as an example of the glass article. However, a glass article other than a glass sheet (for example, a glass roll, a glass tube, or a glass fiber) may also be manufactured.

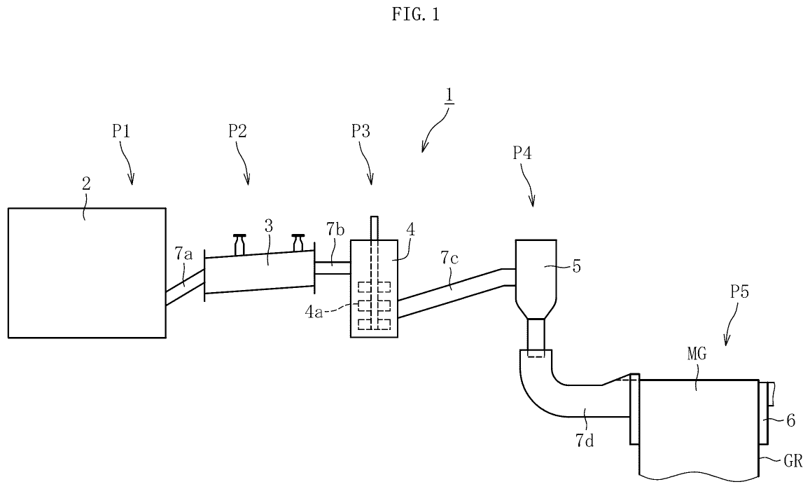

A manufacturing apparatus for a glass article (hereinafter referred to simply as “manufacturing apparatus 1”) illustrated in FIG. 1 is used to perform the manufacturing method for a glass article (hereinafter referred to simply as “manufacturing method”).

The manufacturing apparatus 1 comprises: a melting furnace 2; a fining device 3; a stirring tank 4; a conditioning tank 5; and a forming device 6 in the stated order from an upstream side of flow of a molten glass MG, which is a base material for a glass sheet. Those pieces of equipment are coupled to each other through glass supply passages 7a to 7d. The manufacturing apparatus 1 comprises, in addition to the above-mentioned pieces of equipment, an annealing furnace (not shown) configured to anneal a glass ribbon GR formed by the forming device 6, a cutting device (not shown) configured to continuously cut out glass sheets from the glass ribbon GR that has been annealed, and the like. The obtained glass sheet can be suitably used as a glass substrate or a cover glass in various kinds of displays such as a liquid crystal display and an OLED display. Further, the glass sheet can also be suitably used as a mother glass sheet for manufacturing a platter blank for a hard disk.

In the melting furnace 2, a melting step P1 is carried out. In the melting step P1, glass raw materials are successively fed into the furnace and are melted as they are fed, to thereby continuously produce the molten glass MG. The glass raw materials are added with a fining agent (for example, SnO₂) to be used in a fining step P2 described later. The melting furnace 2 is connected to the fining device 3 through the glass supply passage 7a.

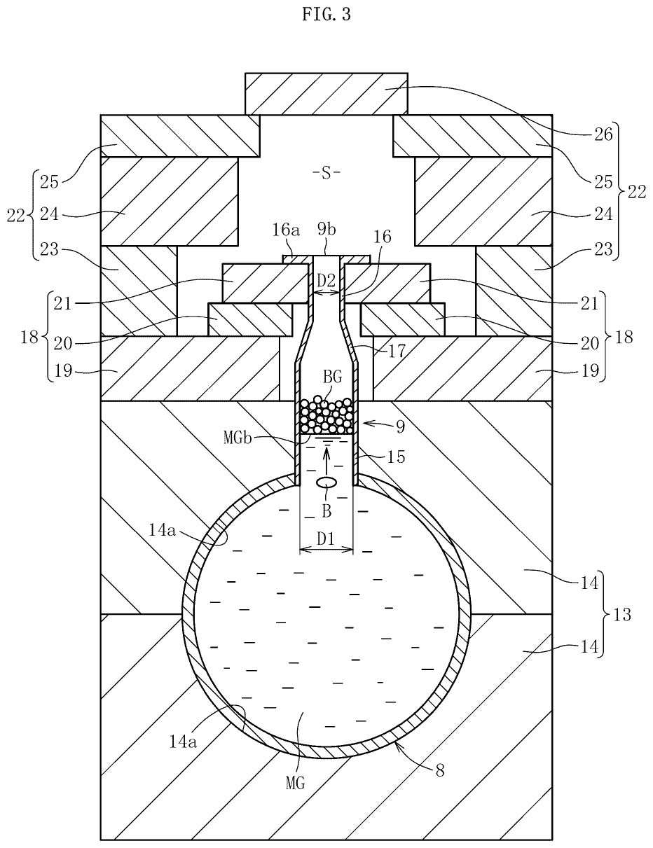

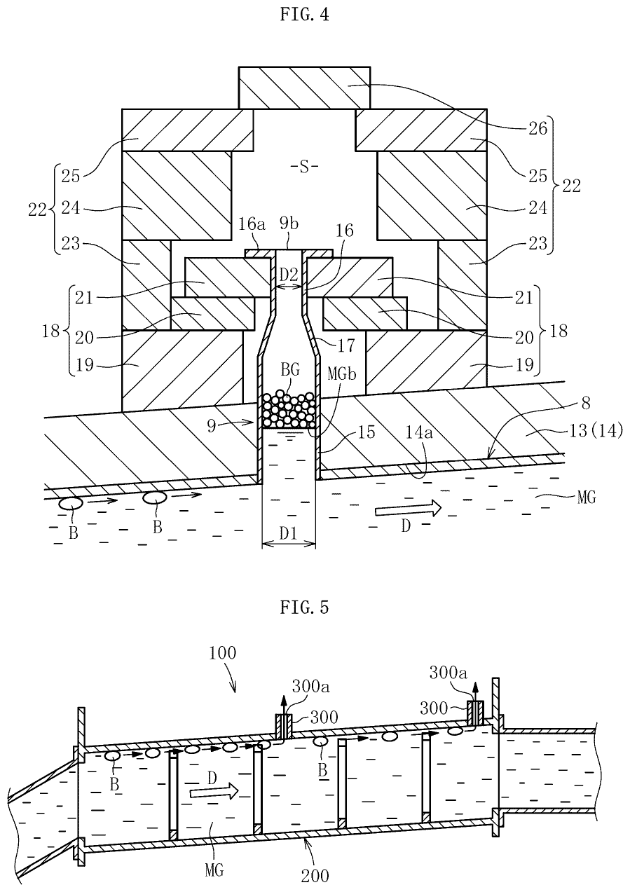

In the fining device 3, a fining step P2 is carried out. In the fining step P2, gas bubbles B (see FIG. 3 and FIG. 4) are removed from the molten glass MG supplied from the melting furnace 2 through the action of the fining agent while heating the molten glass MG so as to reduce its viscosity. The fining device 3 is connected to the stirring tank 4 through the glass supply passage 7b. The details of the fining device 3 are described later.

In the stirring tank 4, a homogenization step P3 is carried out. In the homogenization step P3, the molten glass MG is homogenized by stirring the molten glass MG, which has been fined, with a stirrer 4a equipped with stirring blades. The stirring tank 4 is connected to the conditioning tank 5 through the glass supply passage 7c.

In the conditioning tank 5, a conditioning step P4 is carried out. In the conditioning step P4, a temperature (viscosity), a flow rate, and the like of the molten glass MG are adjusted to make the molten glass MG suitable for forming the glass ribbon GR. The conditioning tank 5 is connected to the forming device 6 through the glass supply passage 7d.

In the forming device 6, a forming step P5 is carried out. In the forming step P5, the glass ribbon GR is continuously formed from the molten glass MG by an overflow down-draw method. The forming device 6 may alternatively employ another forming method such as a slot down-draw method, a redraw method, or a float method to form the glass ribbon GR.

Now, the details of the fining device 3, which is configured to carry out the fining step P2, are described.

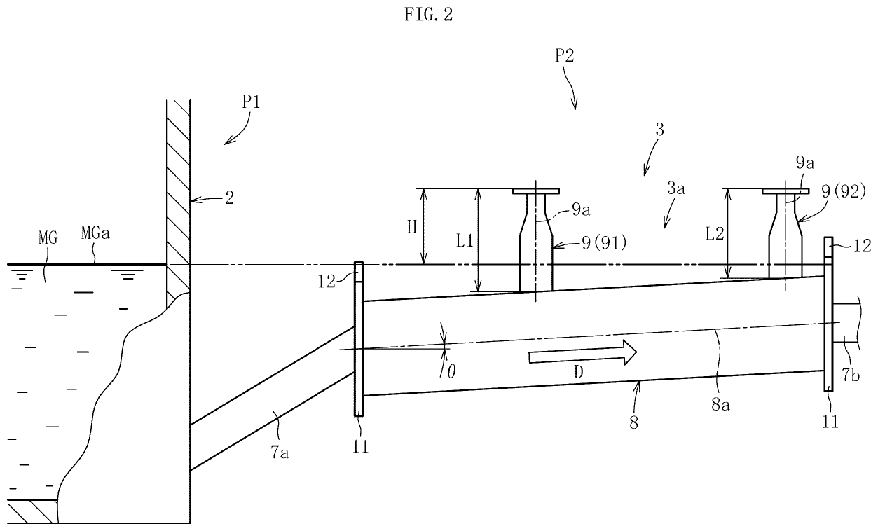

As illustrated in FIG. 2, the fining device 3 comprises a tubular member 3a. The tubular member 3a comprises a fining pipe 8 and vent pipes 9. A plurality of bricks (not shown in FIG. 2) described later is arranged around the fining pipe 8 and the vent pipes 9.

The fining pipe 8 is a pipe that is disposed in a lateral orientation and through which the molten glass MG flows in a flowing direction D. The vent pipes 9 are pipes that extend upward from the fining pipe 8 and discharge the gas bubbles B in the molten glass MG to an outside of the fining pipe 8. Both the fining pipe 8 and the vent pipes 9 are made of a precious metal such as platinum (including strengthened platinum) or a platinum alloy (including a strengthened platinum alloy).

An upstream-side end portion of the fining pipe 8 is connected to the glass supply passage 7a, and a downstream-side end portion of the fining pipe 8 is connected to the glass supply passage 7b. The fining pipe 8 has a substantially cylindrical shape. The fining pipe 8 has a length of, for example, from 1 m to 10 m, and an inner diameter of, for example, from 100 mm to 500 mm. The fining pipe 8 in this embodiment is formed of a single pipe without being divided in a longitudinal direction. However, the fining pipe 8 may be divided into a plurality of pipes in the longitudinal direction, and may be made up of a plurality of pipes that is abutted and connected.

A pipe axis 8a of the fining pipe 8 is inclined with respect to a horizontal plane. Thus, the fining pipe 8 forms an upward slope from the upstream side toward the downstream side in the flowing direction D. An angle θ at which the pipe axis 8a is inclined with respect to the horizontal plane is preferably within the range of 0.25° to 5°, more preferably within the range of 0.5° to 2°. In this manner, a pressure in the molten glass MG on the upstream side inside the fining pipe 8 can be prevented from becoming excessively large if the angle θ is excessively large. Further, the movement of the gas bubbles B in the flowing direction D inside the fining pipe 8 can be promoted due to the inclination, and thus a formation of platinum foreign matter in a glass article (glass sheet in this case), which may be caused due to the stagnation of the gas bubbles B, can be suppressed.

A flange 11 is formed at each of the t upstream-side end portion and the downstream-side end portion of the fining pipe 8 so as to surround an outer peripheral surface of the fining pipe 8. An electrode 12 is formed on an upper portion of each of the flanges 11. When a predetermined voltage is applied to the electrode 12, the fining pipe 8 is electrically heated. Thus, for carrying out the fining step P2, the fining device 3 heats the molten glass MG in the fining pipe 8 to a predetermined temperature (for example, from 1, 300° C. to 1, 500° C.). The flange 11 and the electrode 12 may be provided at positions away from the upstream-side end portion and the downstream-side end portion of the fining pipe 8. The flange 11 and the electrode 12 may be provided at three or more positions. For example, the flange 11 and the electrode 12 may also be provided around an intermediate portion (more specifically, a central portion) of the fining pipe 8 between the upstream-side end portion and the downstream-side end portion.

A pipe axis 9a of each of the vent pipes 9 extends parallel to a vertical direction. The vent pipes 9 are provided at two positions along the fining pipe 8 in the flowing direction D of the molten glass MG. As a matter of course, the positions of the vent pipes 9 are not limited to those described above, and the vent pipes 9 may be arranged at three or more positions. Here, in the following description, the vent pipe 9 arranged on the upstream side in the flowing direction D is sometimes referred to as “upstream-side vent pipe 91”, and the vent pipe 9 arranged on the downstream side is sometimes referred to as “downstream-side vent pipe 92”, so as to distinguish the vent pipes 91 and 92 from each other.

The vent pipe 9 arranged on the upstream side in the flowing direction D is formed longer. That is, the vent pipe 9 arranged at a position at which the pressure in the molten glass MG is higher is formed longer. Thus, a length L1 of the upstream-side vent pipe 91 is greater than a length L2 of the downstream-side vent pipe 92. Here, the terms “length L1” and “length L2” each refer to a length along the pipe axis 9a, which is the length of the portion of the vent pipe 9 protruding from the fining pipe 8. Here, for example, the length L1 is from 50 mm to 400 mm, and the length L2 is from 30 mm to 300 mm.

In this embodiment, the upstream-side vent pipe 91 and the downstream-side vent pipe 92 have the same structure except for a difference in length between L1 and L2. However, the structures of the upstream-side vent pipe 91 and the downstream-side vent pipe 92 are not limited to those described above. The structures of the upstream-side vent pipe 91 and the downstream-side vent pipe 92 may differ in aspects other than the length difference between L1 and L2.

Upper ends of the upstream-side vent pipe 91 and the downstream-side vent pipe 92 are aligned in height. However, the positions of the upper ends are not limited to those described above. As long as the length L1 is greater than the length L2, the upper ends of the upstream-side vent pipe 91 and the downstream-side vent pipe 92 need not be aligned, and either one may be positioned higher than the other.

Both the upper ends of the upstream-side vent pipe 91 and the downstream-side vent pipe 92 are positioned higher than a liquid surface MGa of the molten glass MG in the melting furnace 2. In order to reliably prevent the molten glass MG from flowing out (spurting of bubbly glass BG, described later) from the vent pipes 9, it is preferred that A height difference H between the upper ends of the vent pipes 91 and 92 and the liquid surface MGa of the molten glass MG be preferably 20 mm or more.

As illustrated in FIG. 3 and FIG. 4, the fining pipe 8 is filled with the molten glass MG. That is, the entire inner peripheral surface of the fining pipe 8 is in contact with the molten glass MG. As a result, the gas bubbles B in the molten glass MG move in the flowing direction D while being in contact with a top portion of the fining pipe 8, to reach the vent pipe 9. After that, the gas bubbles B are discharged from an opening 9b of the vent pipe 9.

The fining device 3 further comprises a supporting brick 13 that supports the fining pipe 8 while surrounding it. The supporting brick 13 comprises bricks 14, 14 that are opposed to each other while holding the fining pipe 8 therebetween.

Each of the bricks 14, 14 has a concave surface 14a that conforms to the outer peripheral surface of the fining pipe 8. That is, the concave surface 14a is formed as a partial cylindrical surface. The vent pipes 9 penetrate the upper brick 14. The bricks 14, 14 are, for example, made of refractory bricks with thermal insulation properties, (for example, high zirconia-based refractory bricks: bricks containing 80% to 100% by mass of ZrO₂).

Each of the vent pipes 9 comprises a large-diameter portion 15, a small-diameter portion 16, and a tapered portion 17. The large-diameter portion 15 has a relatively large inner diameter. The small-diameter portion 16 has a relatively small inner diameter. The tapered portion 17 is positioned between the large-diameter portion 15 and the small-diameter portion 16. Both the large-diameter portion 15 and the small-diameter portion 16 have a cylindrical shape. As described above, the vent pipe 9 arranged on the upstream side in the flowing direction D is formed longer. More specifically, the large-diameter portion 15 of the vent pipe 9 arranged on the upstream side in the flowing direction D has a greater length along the pipe axis 9a. As a result, the spurting of the bubbly glass from the vent pipe 9 can be more effectively prevented.

The large-diameter portion 15 is connected to an upper part (top) of the fining pipe 8 and constitutes a lower end portion of the vent pipe 9. Meanwhile, the small-diameter portion 16 constitutes an upper end portion of the vent pipe 9. The opening 9b that allows the gas bubbles B to be discharged is formed at the upper end portion of the vent pipe 9. A flange 16a is formed at an upper end of the small-diameter portion 16. An inner diameter at a lower end of the tapered portion 17 is equal to an inner diameter D1 of the large-diameter portion 15, and an inner diameter at an upper end of the tapered portion 17 is equal to an inner diameter D2 of the small-diameter portion 16. Thus, an inner peripheral surface of the tapered portion 17 is smoothly joined to an inner peripheral surface of the large-diameter portion 15 and an inner peripheral surface of the small-diameter portion 16 without any step or discontinuity.

Here, in view of increasing a capacity of the vent pipe 9 for receiving the bubbly glass BG described later, it is preferred that the inner diameter D1 of the large-diameter portion 15 be 30 mm or more. An upper limit of the inner diameter D1 can be set to, for example, 100 mm or less. Meanwhile, in view of preventing the intrusion of foreign matter through the opening 9b and suppressing temperature drop, it is preferred that the inner diameter D2 of the small-diameter portion 16 be 50 mm or less. A lower limit of the inner diameter D2 can be set to, for example, 20 mm or more.

In the vent pipe 9, a liquid surface MGb of the molten glass MG is positioned inside the large-diameter portion 15, preferably inside a lower part of the large-diameter portion 15 (at or below a middle of the large-diameter portion 15). The pressure in the molten glass MG is higher on the upstream side in the fining pipe 8. Thus, the liquid surface MGb in the upstream-side vent pipe 91 is not at the same height as the liquid surface MGb in the downstream-side vent pipe 92, and actually, is positioned higher than the liquid surface MGb in the downstream-side vent pipe 92.

A layer of the bubbly glass BG is formed above the liquid surface MGb of the molten glass MG in the vent pipe 9. As described above, the liquid surface MGb in the upstream-side vent pipe 91 is positioned higher than the liquid surface MGb in the downstream-side vent pipe 92. Further, when the pipe axis 8a of the fining pipe 8 is inclined with respect to the horizontal plane, the gas bubbles B, which have risen from a deeper position, tend to flow into the upstream-side vent pipe 91 than those flowing into the downstream-side vent pipe 92. Thus, the bubbles contained in the bubbly glass BG are more likely to expand and increase in size inside the vent pipe 9. For the above-mentioned reasons, the bubbly glass BG is more likely to spurt out from the opening 9b of the vent pipe 9 on the upstream side than from that of the vent pipe 9 on the downstream side. In this fining device 3, however, the vent pipe 9 on the upstream side on which the pressure in the molten glass MG is higher is longer. Thus, the spurting of the bubbly glass BG from the vent pipes 9, which may be caused due to the pressure in the molten glass MG, can be prevented.

The fining device 3 further comprises retaining bricks 18, which support a portion of the vent pipe 9 protruding upward from the supporting brick 13 (the whole of the small-diameter portion 16, the whole of the tapered portion 17, and part of the large-diameter portion 15, in this embodiment). Each of the retaining bricks 18 comprises bricks 19 to 21.

The bricks 19 to 21 are all positioned below the opening 9b of the vent pipe 9. Each of the bricks 19 to 21 is divided into a plurality of brick segments, and the plurality of brick segments surround the vent pipe 9. That is, the inner peripheral surfaces of the bricks 19 to 21 are arranged to face an outer peripheral surface of the vent pipe 9. The brick 21 supports the flange 16a located at the small-diameter portion 16 of the vent pipe 9 from below. The inner peripheral surfaces of the bricks 19 to 21 may be in contact with the outer peripheral surface of the vent pipe 9 or may be spaced apart from the outer peripheral surface of the vent pipe 9 so as to define a gap.

At least part of the three bricks 19 to 21 may be formed of a brick having erosion resistance to the molten glass MG (bubbly glass BG) (for example, a high zirconia-based refractory brick). Thus, even when the bubbly glass BG spurts out, the vent pipe 9 can be supported by the brick having erosion resistance. In this embodiment, the brick 21, which is positioned in an uppermost layer in the bricks 19 to 21 and supports the flange 16a from below, is formed of the brick having erosion resistance. Thus, even when the bubbly glass BG spurts out, the erosion of the bricks 19 to 21 can be reliably prevented.

The fining device 3 further comprises a surrounding member 22. The surrounding member 22 surrounds the upper end portion of the vent pipe 9, in which the opening 9b of the vent pipe 9 is formed, and part (bricks 20 and 21) of the retaining brick 18. The surrounding member 22 comprises bricks 23 to 26. Bricks for forming the bricks 23 to 26 are, for example, alumina-zirconia-silica refractory bricks.

Each of the bricks 23 to t 25 is divided into a plurality of brick segments, and the plurality of brick segments surround the upper end portion of the vent pipe 9. The brick 23 is installed on the brick 19 of the retaining brick 18. The brick 26 is positioned immediately above the opening 9b of the vent pipe 9 and serves as a member configured to prevent the intrusion of foreign matter into the opening 9b. The brick 26 can be installed and removed. The installation and the removal of the brick 26 allow a space S defined by the retaining brick 18 and the surrounding member 22 to be closed and opened.

Here, a modification example of the embodiment as described below is possible. In the embodiment, the pipe axis 8a of the fining pipe 8 is inclined with respect to the horizontal plane. However, the pipe axis 8a may be parallel to the horizontal plane. Further, in the embodiment, the pipe axes 9a of the vent pipes 9 extend parallel to the vertical direction. However, the pipe axes 9a may extend in a direction inclined with respect to the vertical direction.

### REFERENCE SIGS LIST

3 fining device
3a tubular member
8 fining pipe
8a pipe axis of fining pipe
9 vent pipe
9a pipe axis of vent pipe
9b opening of vent pipe
91 upstream-side vent pipe
92 downstream-side vent pipe
13 supporting brick
15 large-diameter portion of vent pipe
16 small-diameter portion of vent pipe
18 retaining brick
22 surrounding member
B gas bubble
D flowing direction of molten glass
D1 inner diameter of large-diameter portion
D2 inner diameter of small-diameter portion
MG molten glass
P2 fining step

1. A fining device comprising:
a fining pipe which is disposed in a lateral orientation and is configured to allow a molten glass to flow therethrough; and
a vent pipe which extends upward from the fining pipe and is configured to discharge gas bubbles from the molten glass to an outside of the fining pipe,
wherein a plurality of vent pipes is arranged at multiple positions along the fining pipe in a flowing direction of the molten glass, and
wherein the plurality of vent pipes is arranged such that their lengths increase progressively toward an upstream side in the flowing direction.

2. The fining device according to claim 1,
wherein a pipe axis of the fining pipe is inclined with respect to a horizontal plane, and
wherein the fining pipe forms an upward slope from the upstream side toward a downstream side in the flowing direction.

3. The fining device according to claim 1, wherein a pipe axis of the vent pipe extends parallel to a vertical direction.

4. The fining device according to claim 1,
wherein the vent pipe comprises:
a large-diameter portion having a relatively large inner diameter; and
a small-diameter portion having a relatively small inner diameter,
wherein the large-diameter portion constitutes a lower end portion of the vent pipe which is connected to the fining pipe, and
wherein the small-diameter portion constitutes an upper end portion of the vent pipe in which an opening is formed.

5. The fining device according to claim 1, further comprising a supporting brick that surrounds and supports the fining pipe,
wherein the vent pipe penetrates the supporting brick.

6. The fining device according to claim 5, further comprising a retaining brick which supports a portion of the vent pipe protruding upward from the supporting brick,
wherein at least part of the retaining brick has erosion resistance to the molten glass.

7. The fining device according to claim 1, further comprising a surrounding member which surrounds an upper end portion of the vent pipe in which an opening is formed.

8. A fining device comprising:
a fining pipe which is disposed in a lateral orientation and is configured to allow a molten glass to flow therethrough; and
a vent pipe which extends upward from the fining pipe and is configured to discharge gas bubbles from the molten glass to an outside of the fining pipe,
wherein the vent pipe comprises:
a large-diameter portion having a relatively large inner diameter; and
a small-diameter portion having a relatively small inner diameter,
wherein the large-diameter portion constitutes a lower end portion of the vent pipe which is connected to the fining pipe, and
wherein the small-diameter portion constitutes an upper end portion of the vent pipe in which an opening is formed.

9. A manufacturing method for a glass article using the fining device of claim 1 comprising:
a fining step of discharging gas bubbles from a molten glass that fills the fining pipe to the outside of the fining pipe through the vent pipe.

10. A tubular member for use in a fining device, the tubular member comprising:
a fining pipe which is disposed in a lateral orientation and is configured to allow a molten glass to flow therethrough; and
a vent pipe which extends upward from the fining pipe and is configured to discharge gas bubbles from the molten glass to an outside of the fining pipe,
wherein a plurality of vent pipes is arranged at multiple positions along the fining pipe in a flowing direction of the molten glass, and
wherein the plurality of vent pipes is arranged such that their lengths increase progressively toward an upstream side in the flowing direction.
